(19) United States
(12) Patent Application Publication
(10) Pub. No.: US 2015/0104488 A1
(43) Pub. Date: Apr. 16, 2015

(54) COMPOSITE MATERIAL WITH A SUPPORTING MATERIAL AND AN ANTIMICROBIAL AGENT

(71) Applicant: AMISTEC GMBH & CO. KG, Kossen (AT)

(72) Inventors: Maximilian Lackner, Schwechat (AT); Joseph-Peter Guggenbichler, Kossen (AT)

(73) Assignee: AMISTEC GMBH & CO. KG, Kossen (AT)

(21) Appl. No.: 14/391,778

(22) PCT Filed: Apr. 10, 2013
(86) PCT No.: PCT/EP2013/057506

§ 371 Date: Oct. 10, 2014

(30) Foreign Application Priority Data
Apr. 10, 2012 (DE) 102012103064.2

(51) Int. Cl. A01N 59/16; A01N 25/10; A01N 25/34

(52) U.S. Cl. CPC A01N 59/16; A01N 25/34; A01N 25/10
USPC 424/409; 428/457; 428/689; 442/118; 428/541; 428/315.5; 424/618

(57) ABSTRACT

The invention relates to a composite material with at least one supporting material and at least one antimicrobial agent from the group of metals and metal compounds. The composite material comprises at least one hydrophilizing agent which increases the wettability of the surface of the composite material with water in comparison to the wettability of the surface of the composite material without the addition of the hydrophilizing agent. The invention further relates to a method for producing a composite material.

The invention relates to a composite material with at least one supporting material and at least one antimicrobial agent from the group of metals and metal compounds. Furthermore, the invention relates to a method for producing a composite material, in which a supporting material is provided with at least one antimicrobial agent from the group of metals and metal compounds.

Surfaces can be antimicrobially equipped according to different methods. Besides biocides, metals and metal compounds are often employed for this purpose and employed for antimicrobial equipment of different composite materials. According to the so-called oligodynamic series, a plurality of metal ions is antimicrobially effective, for example including Ag⁺, Cd²⁺, Hg²⁺ and Cu²⁺. Besides copper, silver is particularly often employed, wherein several fundamental possibilities are known. In the first possibility, the elemental metal is provided with a large surface such that the corresponding metal ions can form on the surface. Therefore, nanoparticles, foamed metal or nanoparticles fixed to a support are often used. The second possibility includes the provision of soluble metal salts, which are for example incorporated in zeolites or directly in the composite material. Furthermore, it is possible to represent antimicrobially effective metal ions via the electrochemical series. To this, comparatively less noble metals such as silver or copper can be galvanically coupled to a more noble metal such as for example platinum.

Furthermore, it is known to employ metal compounds such as for instance transition metal oxides to antimicrobially equip composite materials. The transition metal oxides form metal acids upon contact with water such that H₃O⁺ ions are indirectly formed on the surface of the composite material as the antimicrobial agent. Such metal compounds provide better results than metals or metal ions under various conditions since the metal acids are poorly water-soluble and permanent release of metal ions does not have to be effected for maintenance of the antimicrobial effect. Instead, the metal compounds can be used to generate an acidic and thus biocidally effective surface upon contact with water.

The efficiency of such antimicrobial metals or metal ions and metal compounds is to be increased usually in that the composite materials, in which the antimicrobially effective metals and metal compounds are present, are formed as hydrophobic, that is water-repellent, as possible, in order to reduce the wettability of the surfaces of the composite materials and to divest the vital water of bacteria. As the supporting material of such composite materials, therefore, polymers as hydrophobic as possible, such as silicones, polypropylene (PP), acrylonitrile butadiene styrene (ABS), polycarbonate (PC) or polystyrene (PS), are usually employed.

However, in practical employment, it becomes apparent that the efficiency of such composite materials is relatively low in various applications.

It is the object of the present invention to provide a composite material of the initially mentioned kind, which has improved antimicrobial efficiency. It is a further object of the present invention to provide a method for producing such a composite material.

According to the invention, the objects are solved by a composite material having the features of claim 1 as well as by a method according to claim 15. Advantageous configurations with convenient developments of the invention are specified in the respective dependent claims, wherein advantageous configurations of the composite material are to be considered as advantageous configurations of the method and vice versa.

A composite material having improved antimicrobial efficiency is provided according to the invention in that the composite material includes at least one hydrophilizing agent, which increases the wettability of the surface of the composite material with water compared to the wettability of the surface of the composite material without addition of the hydrophilizing agent. Surprisingly, in contrast to the opinion among experts prevailing heretofore, it has turned out that the antimicrobial efficiency can be advantageously increased by the composite material being formed not as hydrophobic as possible, but to the contrary hydrophilic by addition of a hydrophilizing agent. Therein, it can basically even be provided that the composite material is optionally slightly hygroscopic at least in the area of its surface. By hygroscopic, it is to be understood that the composite material absorbs humidity at least on its surface or in the areas near the surface. For example, the composite material is to absorb between 0.01 and 10% by weight of humidity in environments with 10% of relative air humidity. In particular, values of 0.01%, 0.1%, 0.2%, 0.3%, 0.4%, 0.5%, 0.6%, 0.7%, 0.8%, 0.9%, 1.0%, 1.5%, 2.0%, 2.5%, 3.0%, 3.5%, 4.0%, 4.5%, 5.0%, 5.5%, 6.0%, 6.5%, 7.0%, 7.5%, 8.0%, 8.5%, 9.0%, 9.5%, 10.0% as well as corresponding intermediate values are to be understood by values of 0.01 to 10% by weight. 0.1 to 3% of equilibrium moisture content are particularly advantageous, which usually appear after several minutes to hours. The addition of the hydrophilizing agent decreases the surface tension of the composite material and thus generates a more hydrophilic or hygroscopic surface of the composite material. Therein, the invention is based on the realization that a decreased antimicrobial efficiency particularly occurs in hydrophobic composite materials, since these apolar composite materials can contain or bind no or only very little humidity on their surface. In comparison, the composite material according to the invention allows improved wetting of the surface of the composite material with water or aqueous media such that more antimicrobially effective metals, metal ions and/or metal compounds can form or can be released depending on the respective agent. By the composite material according to the invention including one or more hydrophilizing agents besides the antimicrobial agent, thus, the antimicrobial efficiency of the agent can be enhanced on the one hand and the amount of the employed agent can be lowered by up to 95% with the same or better antimicrobial efficiency on the other hand. Hereby, substantial cost savings as well as various further advantages arise since the amount of the metals or metal compounds contained in the composite material or released by the composite material can be advantageously lowered without loss of effect. Although a covalent bond of the hydrophilizing agent and the supporting agent is basically conceivable, the hydrophilizing agent(s) preferably is or are present in the composite material not in covalent bonded manner, but is or are mixed with the supporting agent. Therein, the mixture of supporting agent and hydrophilizing agent basically can be homogenous and single-phase, respectively, or heterogeneous and multi-phase, respectively. The composite material according to the invention is also suitable for various purposes of employment, for which the composite materials known from the prior art could not be used heretofore.

In an advantageous development of the invention, it is provided that the mass ratio of the hydrophilizing agent related to the overall mass of the composite material is between 0.1 and 22% and/or is chosen such that a water drop on the surface of the composite material has a contact angle of less than 90°, in particular between 70° and 30°. Percentage indications are basically d) be understood as mass percentage indications within the scope of the present invention, unless otherwise indicated. Therein, by a mass ratio of the hydrophilizing agent between 0.1 and 22%, in particular mass portions of 0.1%, 0.5%, 1.0%, 1.5%, 2.0%, 2.5%, 3.0%, 3.5%, 4.0%, 4.5%, 5.0%, 5.5%, 6.0%, 6.5%, 7.0%, 7.5%, 8.0%, 8.5%, 9.0%, 9.5%, 10.0%, 10.5%, 11.0%, 11.5%, 12.0%, 12.5%, 13.0%, 13.5%, 14.0%, 14.5%, 15.0%, 15.5%, 16.0%, 16.5%, 17.0%, 17.5%, 18.0%, 18.5%, 19.0%, 19.5%, 20.0%, 20.5%, 21.0%, 21.5% or 22.0% as well as corresponding intermediate values such as for example 0.1%, 0.2%, 0.3%, 0.4%, 0.5%, 0.6%, 0.7%, 0.8%, 0.9%, 1.0% etc. related to the overall mass of the composite material are to be understood. Within the scope of the invention, by the contact angle (also edge angle or wetting angle), the angle is denoted, which a water drop forms on the surface of the composite material to this surface. Hereby, depending on the respectively used hydrophilizing agent or the respectively used mixture of two or more hydrophilizing agents, a particularly good antimicrobial efficiency is ensured without the other mechanical and chemical characteristics of the composite material being appreciably impaired. Therein, the contact angle is a measure of the hydrophobicity or the hydrophilicity of the surface of the composite material. The lower the contact angle is, the more hydrophilic the surface of the composite material is. Therein, composite materials having such a mass portion of hydrophilizing agent that their surface has a contact angle <90° and in particular a contact angle between 70° and 30°, have proven particularly advantageous within the scope of the present invention. Therein, in particular contact angles of 89°, 88°, 87°, 86°, 85°, 84°, 83°, 82°, 81°, 80°, 79°, 78°, 77°, 76°, 75°, 74°, 73°, 72°, 71°, 70°, 69°, 68°, 67°, 66°, 65°, 64°, 63°, 62°, 61°, 60°, 59°, 58°, 57°, 56°, 55°, 54°, 53°, 52°, 51°, 50°, 49°, 48°, 47°, 46°, 45°, 44°, 43°, 42°, 41°, 40°, 39°, 38°, 37°, 36°, 35°, 34°, 33°, 32°, 31°, 30°, 29°, 28°, 27°, 26°, 25°, 24°, 23°, 22°, 21°, 20°, 19°, 18°, 17°, 16°, 15°, 14°, 13°, 12°, 11°, 10°, 9°, 8°, 7°, 6°, 5°, 4°, 3°, 2° or 1°, as well as corresponding intermediate values are to be understood by a contact angle below 90°. Alternatively or additionally, it has proven advantageous if the mass portion of the hydrophilizing agent related to the overall mass of the composite material is chosen such that the contact angle is less by at least 10° compared to the contact angle without addition of the hydrophilizing agent. Hereby, significant increase of the antimicrobial efficiency of the composite material is basically achieved.

By the supporting material being selected from a group including organic polymers, silicones, glasses, ceramics, waxes, resins, dyes, varnishes, textiles, fabrics and/or wood, the composite material according to the invention can be particularly variably configured and be used for very different purposes of application. In particular, aluminum oxide, titanium oxide, silicon oxide, silicon carbide and zirconium oxide are suitable as the ceramic supporting material. In order to be able to resort to the usual production methods and conditions for ceramic, antimicrobial agents present in the highest oxidation stage such as for example MoO₃ and WO₃ are suitable. Besides, metallic Mo and/or W can also be present as antimicrobial agent. Thereby, for example the following material combinations arise as possible ceramic composite materials: Al₂O₃—MoO₃, Al₂O₃—WO₃, ZrO₂—MoO₃, ZrO₂—WO₃, Al₂O₃—Mo—MoO₃, Al₂O₃—W—WO₃, ZrO₂—Mo—MoO₃, ZrO₂—W—WO₃, TiO₂—MoO₃, TiO₂—WO₃, TiO₂—Mo—MoO₃, TiO₂—W—WO₃, SiO₂—MoO₃, SiO₂—WO₃, SiO₂—Mo—MoO₃ and SiO₂—W—WO₃.

Further advantages arise if the supporting material includes a hydrophobic polymer, in particular a polymer from the group of the silicones, polyolefins, polyurethanes (PU, TPU), polypropylenes (PP), polyethylenes (PE), polyethylene terephthalates (PET), polyvinylchlorides (PVC), polystyrenes (PS), polycarbonates (PC), poly(meth)acrylates (e.g. PAA, PAN, PMA, PBA, ANBA, ANMA, PMMA, AMMA, MABS and/or MBS) and/or acrylonitrile butadiene styrenes (ABS). In this manner, the high antimicrobial efficiency of the composite material according to the invention can advantageously also be realized with normally little suitable or even unsuitable hydrophobic supporting materials. Atactic polypropylene exhibits a slightly lower effect than syntactic polypropylene because crystalline structures generally can absorb less humidity. Atactic PP can be admixed with 0.1 to 10% to achieve good hydrophilization and thereby enhanced antimicrobial efficiency.

In further development of the invention, a wide antimicrobial efficiency is realized in that the antimicrobial agent includes a metal, a metal compound and/or a metal alloy from the oligodynamic series and/or that the hydrophilizing agent includes an organic hydrophilizing agent, in particular an ionic and/or non-ionic surface-active organic compound. In particular, the agent can be composed of silver, mercury, copper, cadmium, chromium, lead, cobalt, gold, zinc, iron, manganese, molybdenum, tin, brass and/or bronze. Alternatively, the agent can include two or more metals, metal compounds and/or metal alloys from the oligodynamic series. Hereby, the antimicrobial efficiency can be particularly flexibly adapted to its respective purpose of application of the composite material according to the invention. Conversely, it can basically also be provided that the composite material is formed free of one or more from the group of silver, mercury, copper, cadmium, chromium, lead, cobalt, gold, zinc, iron, manganese, molybdenum, tin, brass and/or bronze and their compounds, respectively. Alternatively or additionally, it has proven advantageous if the hydrophilizing agent includes or is an organic hydrophilizing agent, in particular an ionic and/or non-ionic surface-active organic compound. Organic hydrophilizing agents are available in great variety such that the antimicrobial efficiency of the composite material can be optimally adapted to the respective purpose of employment. The use of surface-active organic compounds offers the particular advantage that they particularly severely lower the interfacial tension between water or the aqueous medium and the composite material and thereby contribute to a particularly good efficiency of the antimicrobial agent.

Further advantages arise if the antimicrobial agent includes a transition metal oxide, in particular MoO₃ and/or WO₃, and/or is obtainable from a transition metal oxide, in particular from MoO₃ and/or WO₃, and/or that the antimicrobial agent is selected from a group including molybdenum, molybdenum compounds, tungsten and tungsten compounds. Hereby, the transition metal oxide can be advantageously used to provide an acidic surface acting in biocidal manner upon contact with water. Also with the use of such metal compounds, it has manifested that a more hydrophilic surface of the composite material allows a significant increase of the antimicrobial efficiency. Therein, the transition metal oxides represent precursors for further antimicrobially effective compounds, which form in situ from these transition metal oxides upon contact with water. For example, complex metal acid mixtures form from MoO₃ and WO₃, which provide for particularly long lasting antimicrobial effect of the composite material even with permanent contact with aqueous mediums due to their low water solubility. Alternatively or additionally to transition metal oxides, the antimicrobial agent can be selected from a group including molybdenum, molybdenum compounds, tungsten and tungsten compounds. For example, compounds such as MoO₂, tungsten blue oxide, molybdenum alloys, tungsten alloy, molybdenum carbide, molybdenum nitride, molybdenum silicide, molybdenum sulfide, tungsten carbide, tungsten nitride, tungsten silicide and tungsten sulfide can be provided. Therein, it has further proven basically advantageous if molybdenum, the molybdenum compounds, tungsten and/or the tungsten compounds are at least partially superficially oxidized.

In a further advantageous development of the invention, it is provided that the antimicrobial agent and/or the hydrophilizing agent function as a proton donator upon contact with an aqueous medium. In this manner, the composite material can be provided with some kind of “acid protection shell”, whereby a particularly high antimicrobial efficiency is given.

In a further advantageous development of the invention, it is provided that the hydrophilizing agent is selected from a group, which includes migrating additives, in particular glycerin monostearate, alginates, collagen, chitosan, gelatin, polyethylene glycol (PEG), polyethylene glycol ester, polypropylene glycol (PPG), polypropylene glycol ester, polycarboxylates, polyacrylic acids, polysaccharides, in particular starch and/or thermoplastic starch, polylactic acid (PLA), humic acids, lignin, maleic acid, erucic acid, oleic acid, stearates, silicagel, in particular fumed silica and/or zeolites, molasses, polydextrose, metal hydroxides, in particular AL(OH)₃ and/or Mg(OH)₂, aluminum oxide, in particular fused alumina, copolymers with acrylic acid, in particular copolymerisates from polystyrene and acrylic acid, acid anhydrides, in particular P₄O₁₀, and glycosaminoglycans, in particular heparin. Similarly, alkylamine alkoxides, DMMB (dimethyl methylene blue) as well as further methylene blue derivatives have proven to be advantageous to hydrophilize the composite material. The selection of the hydrophilizing agent(s) is determined by the planned use of the composite material, which is to be antimicrobially equipped, as well as by the respectively used supporting material or supporting material mixture. Besides the hydrophilization of the composite material, the individual compounds have various additional advantages. Since it is basically sufficient for an improved antimicrobial effect if at least substantially only the surface of the composite material is made more hydrophilic, migrating hydrophilizing agents migrating to the surface of the composite material and expressing their hydrophilic groups on or in the region of the surface of the composite material are suitable. Glycerin monostearate (GMS) offers the additional advantage that it functions as an antistatic agent. Alginates, collagen, chitosan and gelatin as well as other hydrophilic polymers can where desired advantageously be used for swelling the composite material. The same applies to PEG (polyethylene glycol) and PPG (polypropylene glycol) as well as to the esters thereof, wherein PEG 400 generally has proven particularly advantageous. Among the polyacrylic acids, carbomers such as the commercially available Carbopol 960 have proven particularly advantageous. Other commercially available substances are also suitable as the hydrophilizing agent. Those were particularly advantageous: BYK 375, a silicone containing surface additive of the company BYK Additives & Instruments, Marlon ARL of the company Sasol Olefins and Surfactants GmbH, various esters, which can be obtained from the company Croda Chemicals under the trade name Crodamol, and polyoxyethylene oleyl ether phosphates, which are available from the company Rhodia under the trade names Lubrhophos and Rhodafac. Polysaccharides such as starch or thermoplastic starch are also suitable for many applications and provide for an additional supporting effect of the composite material. However, since polysaccharides can also serve as nutriment for the microorganisms, usually only 0.5 to 5% (weight) are reasonable as hydrophilizing agent with polysaccharides. Stearates and commercially available adhesive agents serve as antistatic additives at the same time. Zeolites, silicagel or silicates as fumed silica and aluminates as fumed alumina can absorb or bind particularly great amounts of water related to their mass. Among the commercially available silicates, for example, the product “Cab-O-sil TS720” (Cabot Corporation) has proven particularly advantageous. Molasses can also be used as a low-cost hydrophilizing agent if the dark coloring is tolerable for the desired applications. Metal hydroxides such as Al(OH)₃ or Mg(OH)₂ also lend themselves to hydrophilic equipment of the composite material as well as flame retardant, wherein it has proven advantageous if these hydroxides are added to the composite material in mass portions of up to 20% or more. Further advantageous hydrophilizing agents include copolymers with acrylic acid, wherein copolymerisates of polystyrene (PS) and acrylic acid with 10-90% by weight of acrylic acid have proven particularly advantageous. The use of acid anhydrides such as phosphorus pentoxide (P₄O₁₀) offers the additional advantage that they are severely hygroscopic on the one hand and can generate an acidic and thereby severely bactericidally effective surface on the other hand. Therefore, mass portions of 0.5% related to the overall mass of the composite material are typically sufficient for anhydrides. The use of glycosaminoglycans offers the advantage that the composite material can be additionally equipped with characteristics, which are of particular importance for various medical applications. For example, heparin can be used for providing anticoagulant characteristics, while hyaluronic acid has viscoelastic characteristics.

Further advantages arise in that the antimicrobial agent and/or the hydrophilizing agent are present as particles with an average diameter between 0.1 μm and 200 μm, in particular between 1 μm and 10 μm. Such a particle shape has proven advantageous to allow distribution of the agent and/or the hydrophilizing agent in the matrix of the supporting material as uniform as possible in simple manner, in particular if the agent and/or the hydrophilizing agent are not soluble in the supporting material or not liquid or liquefiable. Moreover, hereby, a particularly large surface of the agent and/or the hydrophilizing agent and a correspondingly high efficiency are achieved. By an average diameter between 0.1 μm and 200 μm, in particular diameters of 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, 45 μm, 46 μm, 47 μm, 48 μm, 49 μm, 50 μm, 51 μm, 52 μm, 53 μm, 54 μm, 55 μm, 56 μm, 57 μm, 58 μm, 59 μm, 60 μm, 61 μm, 62 μm, 63 μm, 64 μm, 65 μm, 66 μm, 67 μm, 68 μm, 69 μm, 70 μm, 71 μm, 72 μm, 73 μm, 74 μm, 75 μm, 76 μm, 77 μm, 78 μm, 79 μm, 80 μm, 81 μm, 82 μm, 83 μm, 84 μm, 85 μm, 86 μm, 87 μm, 88 μm, 89 μm, 90 μm, 91 μm, 92 μm, 93 μm, 94 μm, 95 μm, 96 μm, 97 μm, 98 μm, 99 μm, 100 μm, 101 μm, 102 μm, 103 μm, 104 μm, 105 μm, 106 μm, 107 μm, 108 μm, 109 μm, 110 μm, 111 μm, 112 μm, 113 μm, 114 μm, 115 μm, 116 μm, 117 μm, 118 μm, 119 μm, 120 μm, 121 μm, 122 μm, 123 μm, 124 μm, 125 μm, 126 μm, 127 μm, 128 μm, 129 μm, 130 μm, 131 μm, 132 μm, 133 μm, 134 μm, 135 μm, 136 μm, 137 μm, 138 μm, 139 μm, 140 μm, 141 μm, 142 μm, 143 μm, 144 μm, 145 μm, 146 μm, 147 μm, 148 μm, 149 μm, 150 μm, 151 μm, 152 μm, 153 μm, 154 μm, 155 μm, 156 μm, 157 μm, 158 μm, 159 μm, 160 μm, 161 μm, 162 μm, 163 μm, 164 μm, 165 μm, 166 μm, 167 μm, 168 μm, 169 μm, 170 μm, 171 μm, 172 μm, 173 μm, 174 μm, 175 μm, 176 μm, 177 μm, 178 μm, 179 μm, 180 μm, 181 μm, 182 μm, 183 μm, 184 μm, 185 μm, 186 μm, 187 μm, 188 μm, 189 μm, 190 μm, 191 μm, 192 μm, 193 μm, 194 μm, 195 μm, 196 μm, 197 μm, 198 μm, 199 μm, 200 μm, as well as corresponding intermediate values such as for example 0.10 μm, 0.11 μm, 0.12 μm, 0.13 μm, 0.14 μm, 0.15 μm, 0.16 μm, 0.17 μm, 0.18 μm, 0.19 μm, 0.20 μm, 0.21 μm, 0.22 μm, 0.23 μm, 0.24 μm, 0.25 μm, 0.26 μm, 0.27 μm, 0.28 μm, 0.29 μm, 0.30 μm, 0.31 μm, 0.32 μm, 0.33 μm, 0.34 μm, 0.35 μm, 0.36 μm, 0.37 μm, 0.38 μm, 0.39 μm, 0.40 μm, 0.41 μm, 0.42 μm, 0.43 μm, 0.44 μm, 0.45 μm, 0.46 μm, 0.47 μm, 0.48 μm, 0.49 μm, 0.50 μm, 0.51 μm, 0.52 μm, 0.53 μm, 0.54 μm, 0.55 μm, 0.56 μm, 0.57 μm, 0.58 μm, 0.59 μm, 0.60 μm, 0.61 μm, 0.62 μm, 0.63 μm, 0.64 μm, 0.65 μm, 0.66 μm, 0.67 μm, 0.68 μm, 0.69 μm, 0.70 μm, 0.71 μm, 0.72 μm, 0.73 μm, 0.74 μm, 0.75 μm, 0.76 μm, 0.77 μm, 0.78 μm, 0.79 μm, 0.80 μm, 0.81 μm, 0.82 μm, 0.83 μm, 0.84 μm, 0.85 μm, 0.86 μm, 0.87 μm, 0.88 μm, 0.89 μm, 0.90 μm, 0.91 μm, 0.92 μm, 0.93 μm, 0.94 μm, 0.95 μm, 0.96 μm, 0.97 μm, 0.98 μm, 0.99 μm, 1.00 μm etc. are to be understood.

Further advantages arise if the hydrophilizing agent has a water solubility of at most 10 g/l under SATP conditions and at a pH value of 7. By SATP conditions (“standard ambient temperature and pressure”), therein, the temperature T=298.15 K corresponding to 25° C. and the pressure p=101.300 Pa (1013 hPa, 101.3 kPa, 1.013 bar) are to be understood. By the hydrophilizing agent being poorly water-soluble, fast elution as well as deterioration of the antimicrobial characteristics associated therewith is reliably prevented. For example, the hydrophilizing agent can have a water solubility of 10.0 g/l, 9.9 g/l, 9.8 g/l, 9.7 g/l, 9.6 g/l, 9.5 g/l, 9.4 g/l, 9.3 g/l, 9.2 g/l, 9.1 g/l, 9.0 g/l, 8.9 g/l, 8.8 g/l, 8.7 g/l, 8.6 g/l, 8.5 g/l, 8.4 g/l, 8.3 g/l, 8.2 g/l, 8.1 g/l, 8.0 g/l, 7.9 g/l, 7.8 g/l, 7.7 g/l, 7.6 g/l, 7.5 g/l, 7.4 g/l, 7.3 g/l, 7.2 g/l, 7.1 g/l, 7.0 g/l, 6.9 g/l, 6.8 g/l, 6.7 g/l, 6.6 g/l, 6.5 g/l, 6.4 g/l, 6.3 g/l, 6.2 g/l, 6.1 g/l, 6.0 g/l, 5.9 g/l, 5.8 g/l, 5.7 g/l, 5.6 g/l, 5.5 g/l, 5.4 g/l, 5.3 g/l, 5.2 g/l, 5.1 g/l, 5.0 g/l, 4.9 g/l, 4.8 g/l, 4.7 g/l, 4.6 g/l, 4.5 g/l, 4.4 g/l, 4.3 g/l, 4.2 g/l, 4.1 g/l, 4.0 g/l, 3.9 g/l, 3.8 g/l, 3.7 g/l, 3.6 g/l, 3.5 g/l, 3.4 g/l, 3.3 g/l, 3.2 g/l, 3.1 g/l, 3.0 g/l, 2.9 g/l, 2.8 g/l, 2.7 g/l, 2.6 g/l, 2.5 g/l, 2.4 g/l, 2.3 g/l, 2.2 g/l, 2.1 g/l, 2.0 g/l, 1.9 g/l, 1.8 g/l, 1.7 g/l, 1.6 g/l, 1.5 g/l, 1.4 g/l, 1.3 g/l, 1.2 g/l, 1.1 g/l, 1.0 g/l, 0.9 g/l, 0.8 g/l, 0.7 g/l, 0.6 g/l, 0.5 g/l, 0.4 g/l, 0.3 g/l, 0.2 g/l, 0.1 g/l or less.

In a further advantageous development of the invention, it is provided that the antimicrobial agent and/or the hydrophilizing agent are distributed in the supporting material and/or applied to the supporting material as a coating and/or at least partially have a porous structure with an average pore size between 50 μm and 900 μm. Hereby, the composite material according to the invention can be particularly well adapted to different purposes of use. In particular the duration and the intensity of the antimicrobial effect can be particularly simply adjusted by the distribution of the agent and/or the hydrophilizing agent in and/or on the supporting material. By an open- and/or closed-pore structure, a particularly large surface and thereby a particularly high efficiency is achieved. The average pore size can for example be 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, 300 μm, 310 μm, 320 μm, 330 μm, 340 μm, 350 μm, 360 μm, 370 μm, 380 μm, 390 μm, 400 μm, 410 μm, 420 μm, 430 μm, 440 μm, 450 μm, 460 μm, 470 μm, 480 μm, 490 μm, 500 μm, 510 μm, 520 μm, 530 μm, 540 μm, 550 μm, 560 μm, 570 μm, 580 μm, 590 μm, 600 μm, 610 μm, 620 μm, 630 μm, 640 μm, 650 μm, 660 μm, 670 μm, 680 μm, 690 μm, 700 μm, 710 μm, 720 μm, 730 μm, 740 μm, 750 μm, 760 μm, 770 μm, 780 μm, 790 μm, 800 μm, 810 μm, 820 μm, 830 μm, 840 μm, 850 μm, 860 μm, 870 μm, 880 μm, 890 μm or 900 μm or correspond to a corresponding intermediate value. Alternatively or additionally, a large surface can basically also be achieved by the antimicrobial agent and/or the hydrophilizing agent being present in the form of insular, substantially non-contiguous agglomerates at least in certain areas. It is particularly advantageous if these insular agglomerates cover the surface of the composite material at 40 to 90%. The preferred size of the individual agglomerates is below 10 μm, preferably below 5 μm.

In a further advantageous development of the invention, it is provided that the composite material includes at least one sulfur scavenger, in particular a calcium, zinc, manganese, lead and/or iron compound, wherein the mass ratio, i.e. the mass portion, of the sulfur scavenger related to the overall mass of the composite material is preferably between 0.01% and 0.5%. In antimicrobial composite materials known from the prior art, problems arise for example in that silver can be bound and inactivated by sulfur or sulfur containing additives in supporting materials of plastic. This loss of efficiency is reliably prevented with the aid of the sulfur scavenger in the composite material according to the invention. For example, ZnCl₂ or other salts of iron or manganese can be used as the sulfur scavenger in order that metal scavengers in the supporting material and/or hydrophilizing agent are deactivated or saturated and the developed hardly soluble metal sulfides inactivate the present sulfur. By a mass ratio between 0.01% and 0.5%, in particular mass portions of 0.01%, 0.03%, 0.05%, 0.07%, 0.09%, 0.11%, 0.13%, 0.15%, 0.17%, 0.19%, 0.21%, 0.23%, 0.25%, 0.27%, 0.29%, 0.31%, 0.33% 0.35%, 0.37%, 0.39%, 0.41%, 0.43%, 0.45%, 0.47%, 0.49% a n d 0.5% as well as corresponding intermediate values related to the overall mass of the composite material are to be understood.

In further development of the invention, the composite material is formed as a coating agent, in particular as a painting agent, varnish and/or antifouling paint. Embodiments of the composite material are understood by a painting agent, which have a liquid to pasty consistency and which result in a physically or chemically dry paint applied to surfaces. Hereby, the advantageous characteristics of the composite material according to the invention can be particularly flexibly realized for any objects and surfaces. Important developments are for example anti-fouling paints, e.g. for ships, as well as antimicrobial equipment in the health care system, the industry, the food sector and the private sector.

In a further advantageous development of the invention, it is provided that the mass portion of the antimicrobial agent related to the overall mass of the composite material is at least 0.1%, preferably at least 1.0%. For example, the mass portion or the mass ratio can be 0.1%, 1%, 2%, 3%, 4%, 5%, 6%, 7%, 8%, 9%, 10%, 11%, 12%, 13%, 14%, 15%, 16%, 17%, 18%, 19%, 20%, 20%, 21%, 22%, 23%, 24%, 25%, 26%, 27%, 28%, 29%, 30%, 31%, 32%, 33%, 34%, 35%, 36%, 37%, 38%, 39%, 40% or more related to the overall mass of the composite material. Of course, corresponding intermediate values such as for example 0.1%, 0.2%, 0.3%, 0.4%, 0.5%, 0.6%, 0.7%, 0.8%, 0.9%, 1.0% etc. are to be considered as expressly disclosed also in this case.

A further aspect of the invention relates to a method for producing a composite material, in which a supporting material is provided with at least one antimicrobial agent from the group of the metals and metal compounds as well as with at least one hydrophilizing agent, which increases the wettability of the surface of the composite material with water compared to the wettability of the surface of the composite material without addition of the hydrophilizing agent. Surprisingly, in contrast to the opinion among experts prevailing heretofore, it has turned out that the antimicrobial efficiency can be advantageously increased by the composite material being not formed as hydrophobic as possible, but to the contrary hydrophilic by addition of a hydrophilizing agent. The addition of the hydrophilizing agent decreases the surface tension of the composite material and thus generates a more hydrophilic or hygroscopic surface of the composite material. Therein, the invention is based on the realization that a reduced antimicrobial efficiency occurs particularly in hydrophobic composite materials since these apolar composite materials can contain or bind no or very little humidity on their surface. In comparison, the composite material produced according to the invention allows improved wetting of the surface of the composite material with water such that more antimicrobially effective metals, metal ions and/or metal compounds can form or can be released depending on the respective agent. By the composite material produced according to the invention including one or more hydrophilizing agents besides the antimicrobial agent, thus, the antimicrobial efficiency of the agent can be enhanced on the one hand and the amount of the employed antimicrobial agent can be lowered by up to 95% with the same or better antimicrobial efficiency on the other hand. Hereby, substantial cost savings as well as various further advantages arise since the amount of the metals or metal compounds contained in the composite material or released by the composite material can be advantageously reduced without loss of effect.

Thus, the composite material produced according to the invention is also suitable for various purposes of employment, for which the composite materials known from the prior art could not be used heretofore. Further advantages arising can be taken from the previous descriptions to the composite material according to the invention, wherein advantageous developments of the composite material according to the invention are to be considered as advantageous developments of the method according to the invention and vice versa.

In an advantageous development of the invention, it is provided that the supporting material is coated with the antimicrobial agent and/or with the hydrophilizing agent and/or that the antimicrobial agent and/or the hydrophilizing agent are preferably uniformly distributed in the supporting material. Hereby, the composite material according to the invention can be particularly well adapted to different purposes of use. In particular, the duration and the intensity of the antimicrobial effect can be particularly simply adjusted by the distribution of the agent and/or the hydrophilizing agent in and/or on the supporting material.

Further advantages arise if the antimicrobial agent and/or the hydrophilizing agent are ground to a grain size between 0.1 μm and 200 μm, in particular between 1 μm and 10 μm, before coating and/or distributing. Such a particle shape has proven advantageous to allow distribution of the agent and/or the hydrophilizing agent in the matrix of the supporting material as uniform as possible in simple manner, in particular if the agent and/or the hydrophilizing agent are not soluble in the supporting material or not liquid or liquefiable. Moreover, hereby, a particularly large surface of the agent and/or the hydrophilizing agent and a correspondingly high efficiency are achieved.

A third aspect of the invention relates to the use of a composite material according to the first inventive aspect and/or a composite material obtainable and/or obtained by means of a method according to the second inventive aspect, for producing a cladding for a conduit, in particular for a pipeline for liquids, gases and/or sludges. Bacteria such as for example sulfate binding bacteria in oil and gas pipelines present a great problem since they severely contribute to corrosion of the pipelines and thereby to leakage formation. The same can also be observed in water and sludge carrying conduits and pipelines such as for example water or wastewater conduits. However, from outside too, pipelines are attacked by bacteria and other microorganisms, for example in conduits laid in the earth. By the composite material according to the invention being used for producing an interior and/or exterior cladding of a conduit, the antimicrobial characteristics of the composite material can be advantageously utilized both for antimicrobial equipment of new conduits and for repairing existing conduits. Therein, the cladding can basically have one or more layers, wherein at least one layer contains the composite material. Preferably, at least one external layer of the cladding contains the composite material according to the invention. Further features and the advantages thereof can be taken from the descriptions of the first and the second inventive aspect, wherein advantageous developments of the first and the second inventive aspect are to be considered as advantageous developments of the third inventive aspect and vice versa.

A fourth aspect of the invention relates to a cladding for a conduit, in particular for a pipeline for liquids, gases and/or sludges, which includes a layer system with at least one layer, wherein at least one layer contains or is composed of the composite material according to the first inventive aspect and/or the composite material obtainable and/or obtained by means of a method according to the second inventive aspect. Further features and the advantages thereof can be taken from the descriptions of the first and the second inventive aspect, wherein advantageous developments of the first and the second inventive aspect are to be considered as advantageous developments of the fourth inventive aspect and vice versa.

Further features of the invention are apparent from the claims, the embodiments as well as based on the drawings. The features and feature combinations mentioned above in the description as well as the features and feature combinations mentioned below in the embodiments are usable not only in the respectively specified combination but also in other combinations without departing from the scope of the invention. There shows:

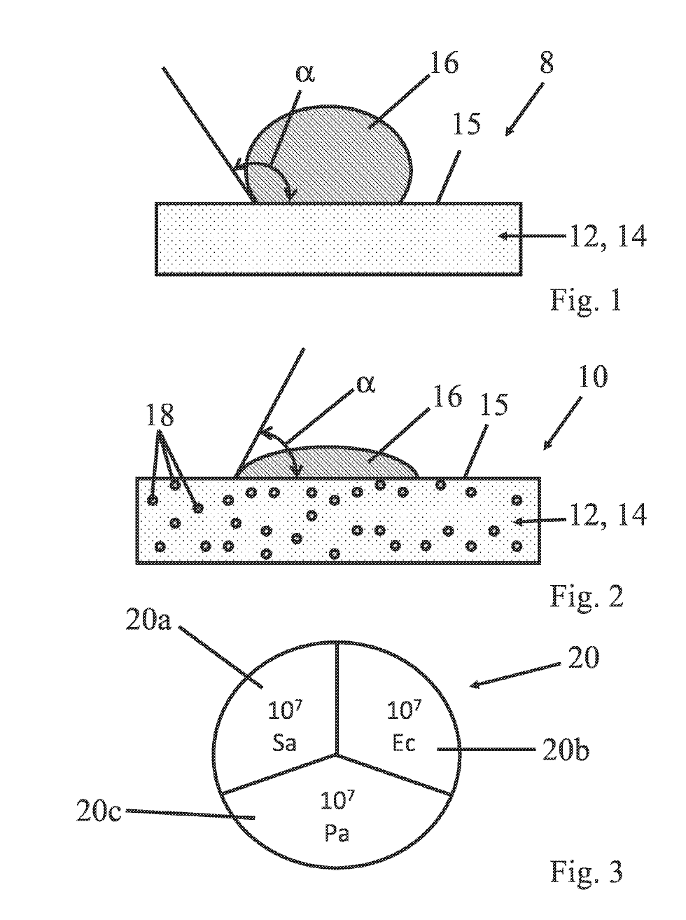

FIG. 1 a schematic lateral sectional view of a composite material without hydrophilizing agent, wherein a water drop is disposed on the surface of the composite material;

FIG. 2 a schematic lateral sectional view of a composite material according to the invention with hydrophilizing agent, wherein a water drop is disposed on the surface of the composite material;

FIG. 3 a schematic diagram of a Petri dish, which is divided into three sectors with respectively different bacterial load;

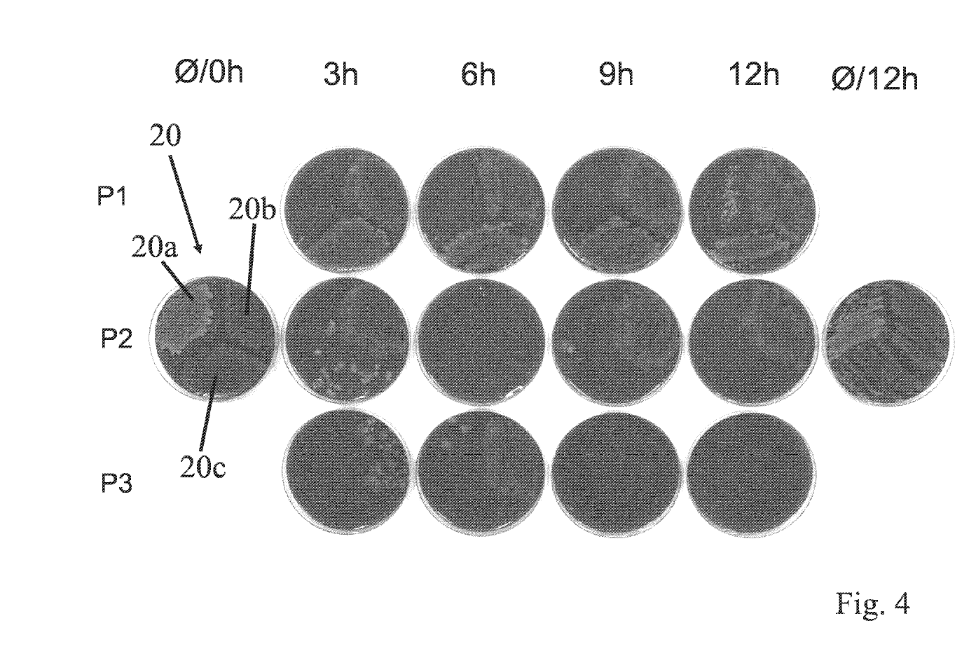

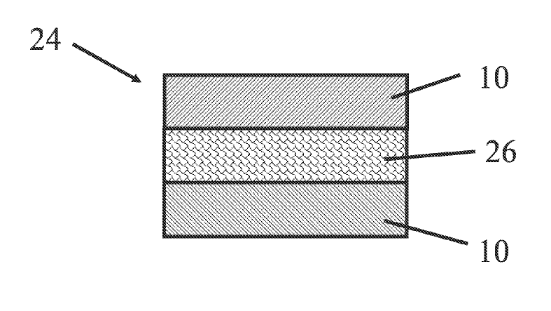

FIG. 4 a photograph of several Petri dishes from a test series for examining the antimicrobial efficiency of three different composite materials;

FIG. 5 a schematic sectional view of a cladding for a conduit, wherein the cladding contains the composite material according to the invention.

FIG. 1 shows a schematic lateral sectional view of a composite material 8 known from the prior art, which includes a hydrophobic supporting material 12 such as for example polypropylene, wherein an antimicrobial agent 14 symbolized with dots, such as for example nanosilver, is uniformly distributed in the supporting material 12. A water drop 16 is disposed on the surface 15 of the composite material 8, which has a contact angle cc of about 120°. One recognizes that the conventional composite material 8 is poorly wettable. The reason for this is in that hydrophobic plastics such as polypropylene, thermoplastic urethane (TPU) and the like have an equilibrium moisture content of 0.5% to 4%, that is they absorb about 4% of water at the maximum form the air humidity. However, water is essential for the formation of antimicrobially effective metal ions and metal acids from the antimicrobial agent 14. Therefore, the shown composite material 8 has a comparatively low antimicrobial efficiency.

FIG. 2 shows a schematic lateral sectional view of a composite material 10 according to the invention, which also includes a hydrophobic supporting material 12 such as for example polypropylene, wherein an antimicrobial agent 14 symbolized with dots, such as for example nanosilver, is uniformly distributed in the supporting material 12. Unlike the composite material 8 shown in FIG. 1, the composite material 10 according to the invention additionally has a hydrophilizing agent 18 symbolized with circles such as for example polyethylene glycol (PEG 400), polypropylene glycol ester (PPG ester), polylactic acid (PLA) or heparin.

One recognizes that the wettability of the surface 15 of the composite material 10 with water is considerably increased compared to the wettability of the surface 15 of the composite material 8 without addition of the hydrophilizing agent 18 shown in FIG. 1. The water drop 16 now has a contact angle cc of about 65°. A measurement of the contact angle cc of a water drop on the surface 15 shows very fast and simply if an improvement of the antimicrobial efficiency is achieved Generally, the contact angle should be α<90°, better less than 70°. Usually, it is not required to achieve a contact angle α<30°. However, in some systems, down to 5° and below are possible after addition of the hydrophilizing agent 18. Therein, the hydrophilizing agent(s) 18 basically cannot only be mixed in the supporting material 12, but alternatively or additionally also be coated on it as a coating. Similarly, it can basically be provided that the antimicrobial agent 14 is not only mixed in the supporting material 12, but alternatively or additionally is applied on it. By the simultaneous application of the agent 14 and the hydrophilizing agent 18, the antimicrobial efficiency of the composite material 10 can either be enhanced or the amount of the employed agent 14 can be considerably decreased, however at least decreased by at least 10% and by up to 95%, which has a positive influence on the environment and cost. The uppermost 1-10 nm of the surface 15 is crucial for the wettability and the contact angle α, respectively. They determine the contact angle cc of the water drop 16 and thus the hydrophilicity of the surface 15. Therefore, it is basically possible to use migrating hydrophilizing agents 18, which migrate from the supporting material 12 to the surface 15 and for example express OH groups on the surface. It has manifested that usually 0.1 to 5% (by mass related to the overall formulation in the equipment of the entire composite material 10) of hydrophilizing agent 18 exhibit a good effect. The selection of the hydrophilizing agent 18 or the mixture of several hydrophilizing agents 18 in particular is determined by the application and the supporting material 12, which is to be antimicrobially equipped. The following substances and the derivatives thereof have proven advantageous:
GMS (glycerin monostearate), which is employed as an antistatic agent;
alginates, collagen, chitosan and gelatin as well as other substances, which ensure swelling in polymers and other materials;
PEG (polyethylene glycol) and PPG (polypropylene glycol) as well as the esters thereof (PEG 400 is particularly advantageous);
polycarboxylates;
alkylamine alkoxides (alkylamine ethoxylate is particularly advantageous);
polyacrylic acids (carbomers, Carbopol 960™ is particularly advantageous);
polysaccharides such as starch (thermoplastic starch is particularly advantageous. However, starch is not suitable for all applications because it can also constitute a nutrition medium for microorganisms);
polylactic acid (PLA);
humic acids and lignin;
maleic acid, erucic acid, oleic acid;
stearates and commercially available adhesive agents and antistatic additives;
silicagel, fumed silica, fumed alumina and zeolites, which are able to absorb water (fused silica “TS720” (Cabot) is particularly advantageous);
molasses (not suitable for all applications due to the coloring);
polydextrose;
dimethyl methylene blue (DMMB);
Al(OH)₃, Mg(OH₂) and other hydroxides (up to 20% by weight are required)
copolymers with (meth)acrylic acid. Copolymerisates from PS and (meth)acrylic acid are particularly advantageous (10-90% (meth)acrylic acid);
acid anhydrides such as P₄O₁₀ (here, 0.5% by weight are typically sufficient); or
glycosaminoglycans, e.g. heparin.

A uniform distribution of the hydrophilizing agent 18 in the matrix of the supporting material 12 has proven advantageous. If the hydrophilizing agents 18 and optionally further additives are not soluble in the material system or are not liquid in processing (mixing, compounding, cutting etc.), they should be ground before to a grain size between 0.1 and 100 μm. Average grain diameters between 1 μm and 10 μm are preferred. The hydrophilizing agent(s) 18 should be poorly water soluble whenever possible since otherwise they could be too fast eluted.

The following table 1 shows three further embodiments of the composite material 10 according to the invention.

TABLE 1
Three embodiments of the composite material 10 according to the
invention

| Example | 1 | | 2 | | 3 | |
|---|---|---|---|---|---|---|
| Supporting | Polypropylene | 92.90% | Polypropylene | 95.90% | Polypropylene | 95% |
| material | (PP) | | (PP) | | (PP) | |
| Antimicrobial | Ag, applied to | 5% | Ag (as Ag- | 2% | WO₃ mixed in | 2% |
| agent | supporting | | NO₃) mixed in | | supporting | |
| | material as | | supporting | | material and | |
| | nanoparticles | | material | | applied to | |
| | | | | | supporting | |
| | | | | | material | |
| Hydrophilizing | PEG 400 | 2% | PPG ester | 2% | PLA | 3% |
| agent | | | | | | |
| Inactivator for | ZnCl₂ | 0.10% | ZnCl₂ | 0.10% | — | |
| disturbing | | | | | | |
| additives (sulfur | | | | | | |
| scavenger) | | | | | | |

As shown in the embodiments 1 and 2, further additives can be mixed especially to silver containing composite materials 10 in the range from 0.01 to 0.5% (by mass). Herein, ZnCl₂ or other salts from iron and manganese are particularly advantageous, in order that the metal scavengers in the plastic are deactivated (saturated) and developing, hardly soluble metal sulfides inactivate the present sulfur. By the additive, the efficiency of the composite material 10 can be accelerated, enhanced and temporally extended.

Table 2 exemplarily shows, for which hydrophilizing agents 18 in plastics and in paints and varnishes, respectively, together with the antimicrobial agent 14 particularly good results have been achieved.

TABLE 2
Qualitative comparison of the hydrophilizing and hygroscoping effect of
different hydrophilizing agents in plastics (PP, ABS) and paints and
varnishes (epoxy resin, acrylic varnish, PU varnish), respectively

| | | Particularly | | Particularly | Good |
|---|---|---|---|---|---|
| | Hydrophilizing | good in | Good in | good in | in |
| No. | agent | plastics | plastics | paints | paints |
| 1 | PEG | | + | + | |
| 2 | PEG 400 | | + | + | |
| 3 | Ruco-coat AD 7025 | | + | | |
| 4 | Polyquart Ecoclean | | + | | |
| 5 | Tech Mer PPM | | + | | |
| | 15560 | | | | |
| 6 | BYK 375 | | + | + | |
| 7 | Carbopol EZ-2 | + | | | |
| 8 | Carbopol EZ-4 | | + | | |
| 9 | Carbopol 690 | + | | + | |
| 10 | Marlon ARL | | + | | |
| 11 | Starch | | | | |
| 12 | Alkylamine | + | | + | |
| | ethoxylate | | | | |
| 13 | GMS | + | | + | |
| 14 | Polydextrose | | | | + |
| 15 | Crodamol AB-LQ- | | | | + |
| | (RB) | | | | |
| 16 | Crodamol OHS-LQ- | | | | + |
| | (RB) | | | | |
| 17 | Crodamol OPG-LQ- | | | | + |
| | (RB) | | | | |
| 18 | Lubrhophos LM 400 | | | | + |
| | E | | | | |
| 19 | Lubrhophos RD 510 | | | | + |
| | E | | | | |
| 20 | Rhodafac PA-23 | | | | + |
| 21 | Rhodafac PA32 | | | | + |
| 22 | Strodex NB-20 | | | | + |
| 23 | Dextrol OC-60 | | | | + |
| 24 | Mirapol S-410 | | | | + |
| 25 | Dimethyl methylene | | + | | + |
| | blue | | | | |

The composite material 10 according to the invention can basically be formed solid or liquid at room temperature. Basically, natural and synthetic polymers can be used as the supporting material 12. The use of apolar plastics such as PE, PP, PS, PC, ABS, silicone, resins and/or waxes as the supporting material 12 is particularly advantageous. For example, the composite material 10 can be formulated as a paint or varnish and include a solvent and/or dispersant as well as color pigments or further ingredients.

According to this invention, it is possible to employ all of the known substances and methods for hydrophilization of solid and liquid composite materials 10 based on polymers, silicones, paints, varnishes, resins, waxes and the like, which contain at least one antimicrobial agent 14, in order to thereby increase the wettability (hydrophilicity, hygroscopicity) of the composite material 10 and thus to improve the antimicrobial efficiency. Important embodiments of the composite material 10 are also anti-fouling paints e.g. for ships as well as antimicrobial equipments in the health care system, the industry, the food sector and the private sector.

Further fundamental possibilities of employment of the composite material 10 according to the invention for antimicrobial equipment of objects include the use for medical devices, medical apparatuses and consumable goods, medical offices, retirement and care homes, industrial plants and machines, food engineering, transport systems, packages, prevention of diesel pest/fouling, public transport, waiting rooms, public and non-public toilets and baths, self-service machines, household appliances, electric appliances, kitchen and sanitary surfaces, textiles, telephones computer and telephone keyboards, adjusting screws, monitoring, respiration apparatuses, infusion pumps, O₂, CO₂ etc. monitors, writing instruments, cardex, ward round trolleys, stethoscopes, door handles, water fittings and floors in exemplary and non limiting manner.

FIG. 3 shows a schematic diagram of a Petri dish 20 provided with an agar plate, which is divided into three sectors 20a, 20b, 20c with respectively different bacterial load. In the following, FIG. 3 will be explained in synopsis with FIG. 4, in which a photograph of several Petri dishes 20 from a test series for examining the antimicrobial efficiency of three different composite materials 10 is shown.

In particular, the method of roll-out culture has proven successful for examining the antimicrobial efficiency of composite materials 10. Herein, the examined composite materials 10 are placed in corresponding germ suspensions for examining their antimicrobial efficiency. Superficial growth of germs occurs. After 3, 6, 9 and 12 hours, the samples are rolled over an agar plate and placed in a sterile, physiological sodium chloride solution. After this rolling operation, the agar plates or Petri dishes 20 are photographed and assessed with respect to the germ reducing or germ killing effect of the concerned composite material 10. This repeated rolling action in 3-hour interval gives indication if and with which degree of efficiency a germ reducing or germ killing effect occurs. This method can be applied for the examination of various microbes, bacteria and viruses. The examinations to the verification of effect of the composite materials 10 according to the invention were effected separately for the reference strains Staphylococcus aureus (Sa, suspension with 10⁷ KBE/ml (colony forming units per milliliter)), Escherichia coli (Ec, suspension with 10⁷ KBE/ml) and Pseudomonas aeroginosa (Pa, suspension with 10⁷ KBE/ml). The agar plates were divided into the three sectors 20a-c as shown in FIG. 3, wherein the results are recognizable for Staphylococcus aureus in the sector 20a, for Escherichia coli in the sector 20b and for Pseudomonas aeroginosa in the sector 20c.

The composite material 8 designated with P1 in FIG. 4 served as a comparison and included polyacrylate as the supporting material 12 and MoO₃ as the antimicrobial agent 14. The composite material 10 designated with P2 in FIG. 4 was formed according to the invention and included additionally 2% of PEG as a hydrophilizing agent 18 besides the supporting material 12 polyacrylate and the antimicrobial agent 14 MoO₃. The composite material 10 designated with P3 in FIG. 4 was also formed according to the invention and included additionally 4% of PEG as the hydrophilizing agent 18 besides the supporting material 12 polyacrylate and the antimicrobial agent 14 MoO₃. In addition, a control of polyacrylate without antimicrobial agent 14 and without hydrophilizing agent 18 is denoted with the symbol “Ø”.

In FIG. 4, it is recognizable that the antimicrobial effect is already basically present in the sample P1 known from the prior art compared to the control “Ø”. However, depending on the portion of hydrophilizing agent 18, this antimicrobial effect can be yet considerably increased in the samples P2 and P3 such that in the sample P3 virtually no germs are detectable anymore already after 9 hours.

Further embodiments of the composite material 10 according to the invention include the following samples, which have been examined for their antimicrobial efficiency, as described above:
polypropylene (PP)+2% by weight MoO₃+2% by weight hydrophilizing agent;
PP+2% by weight MoO₃+4% by weight hydrophilizing agent;
PP+2% by weight MoO₃+6% by weight hydrophilizing agent;
polyethylene with 2% MoO₃ (β phase) and 3% hydrophilizing agent;
plastic K18+2% β-MoO₃+1% WO₃+2% hydrophilizing agent Crodamide ER (fatty acid amides)
K18+2% β-MoO₃+2% WO₃+2% hydrophilizing agent Hostastat (=ethoxylated alkylamines)
K18+2% β-MoO₃+2% hydrophilizing agent Crodamide ER
K18+2% β-MoO₃+2% hydrophilizing agent Crodamide BR
K18+2% β-MoO₃+2% hydrophilizing agent sorbic acid (=hexadienoic acid)
PP+2% WO₃+1% hydrophilizing agent Crodafos MCA-SO (solid cetyl phosphate esters)
PP+2% WO₃+1% hydrophilizing agent Lubrophos LM-400E (=ethoxylated nonylphenol phosphates)
PP+2% WO₃+1% hydrophilizing agent Pluronic PE 8100 (=little foaming, non-ionic surfactants, block copolymers, in which the central polypropylene glycol group is flanked by two polyethylene glycol groups)
PP+2% WO₃+1% hydrophilizing agent Surfynol 440 (=ethoxylated wetting agent)
PP+2% WO₃+1% hydrophilizing agent sodium dodecyl sulfate
PP+2% calcinated molybdic acid (AA)+2% hydrophilizing agent Orevac PP CA100 (chemically functionalized polypropylene with high content of grafted maleic anhydride)
PP+2% WO₃+1% hydrophilizing agent Crodamol OHS (=propylene glycol polyethylene glycol-3-isocetylether acetate)
PP+2% WO₃+1% hydrophilizing agent Pluronic PE 8100 (=non-ionic surfactant)
PP+2% WO₃+1% hydrophilizing agent Flerol KFC (=polyglycol ether)
PP+2% WO₃+1% hydrophilizing agent BYK P4100 (=BYK-P4100 is a copolymer with acid groups, which is free of silicones and waxes)
PP+2% WO₃+1% hydrophilizing agent Disperplast 1150 (=polar, acidic ester of long-chain alcohols)
PP+2% WO₃+1% hydrophilizing agent Disperplast 1018 (=copolymer with pigment affinic groups)
PP+2% MoO₃+1% hydrophilizing agent Atmer 129 MB (=Atmer 129 is a plant glycerol ester)
PP+2% MoO₃+1% hydrophilizing agent Palsgaard DMG0093 (=Palsgaard DMG 0093 is an emulsifier based on distilled monoglycerides of plant fatty acids)

Further examples include:
Thermoplastic polyurethane (TPU) 1180A+2% ADT-304-100
TPU 1180A+2% ADT-CY-304-25
TPU 1180A+2% ADT-CY-304-75
TPU 1180A+2% ADT-402-140

There denote:

ADT=diammonium tungsten
CY=cyclone dried
X-Y=calcination temperature profile in ° C., for example 304−100=304° C. to 100° C.

All of the samples were tested for their efficiency against S. aureus (109 CFU/ml, 4 hours of incubation). After 12 hours at the latest, virtually no germs were detectable anymore in all of the samples, wherein no germs were detectable anymore already after about 3-6 hours in many samples.

FIG. 5 shows a schematic sectional view of a basically tubularly formed cladding 24 for a conduit, for example for a water, oil or gas pipeline, wherein the cladding 24 contains a layer system with three layers exemplary in number and arrangement. Therein, the upper and the lower layer are composed of the composite material 10 according to the invention and each include a plastic such as for example PVC in the shown embodiment, in which a molybdenum and/or tungsten oxide as the antimicrobial agent 14 as well as a hydrophilizing agent 18 are incorporated. Therein, the individual layers can be basically formed in identical or different manner. Between the external layers of the composite material 10, there is an intermediate reinforcing layer 26, which contains a textile fabric, for example from Kevlar, in the shown embodiment. The reinforcing layer 26 can basically also be antimicrobially equipped or be composed of the composite material 10, but must not be composed of the composite material 10. Since both the outer and the inner layer are composed of the composite material 10 according to the invention, microbes can be combated both on the inside and on the outside of the cladding 24. This is for example of great advantage in oil pipelines, because hereby the bacteria adhering to the inside of the pipeline and the bacteria entrained with the flowing oil can be combated at the same time. The cladding 24 has a certain flexibility or deformability and can also be inserted by machine in conduits, pipelines and the like as an inner cladding for repair and/or for antimicrobial equipment. Alternatively or additionally, the cladding 24 can also be used as an external cladding for conduits, pipelines and the like.

The parameter values specified in the documents for defining process and measurement conditions for the characterization of specific properties of the inventive subject matter are to be considered as encompassed by the scope of the invention even within the scope of deviations for example due to measurement errors, system errors, weighing errors, DIN tolerances and the like.

1. A composite material comprising:
at least one supporting material and at least one antimicrobial agent from the group of the metals and metal compounds
wherein the composite material includes at least one hydrophilizing agent (18), which increases the wettability of the surface of the composite material with water compared to the wettability of the surface of the composite material without addition of the hydrophilizing agent.

2. The composite material of claim 1, wherein the mass ratio of the hydrophilizing agent related to the overall mass of the composite material is between 0.1% and 22% and/or is chosen such that a water drop on the surface of the composite material has a contact angle (α) of less than 90°, in particular between 70° and 30°, and/or is chosen such that the contact angle (α) is less by at least 10° compared to the contact angle (α) without addition of the hydrophilizing agent.

3. The composite material of claim 1, wherein the supporting material is selected from a group including organic polymers, silicones, glasses, ceramics, waxes, resins, paints, varnishes, textiles, fabrics and/or wood.

4. The composite material of claim 3, wherein the supporting material includes a hydrophobic polymer, in particular a polymer from the group of the silicones, polyolefins, polyurethanes, polypropylenes, polyethylenes, polyethylene terephthalates, polyvinylchlorides, polystyrenes, polycarbonates, poly(meth)acrylates and/or acrylonitrile butadiene styrenes.

5. The composite material of claim 1, wherein the antimicrobial agent includes a metal, a metal compound and/or a metal alloy from the oligodynamic series and/or that the hydrophilizing agent includes an organic hydrophilizing agent, in particular an ionic and/or non-ionic surface-active organic compound.

6. The composite material of claim 1, wherein the antimicrobial agent includes a transition metal oxide, in particular MoO₃ and/or WO₃, and/or is obtainable from a transition metal oxide, in particular from MoO₃ and/or WO₃, and/or that the antimicrobial agent is selected from a group including molybdenum, molybdenum compounds, tungsten and tungsten compounds.

7. The composite material of claim 1, wherein the antimicrobial agent and/or the hydrophilizing agent function as a proton donator upon contact with an aqueous medium.

8. The composite material of claim 1, wherein the hydrophilizing agent is selected from a group, which includes migrating additives, in particular glycerin monostearate, alginates, collagen, chitosan, gelatin, polyethylene glycol (PEG), polyethylene glycol ester, polypropylene glycol (PPG), polypropylene glycol ester, polycarboxylates, polyacrylic acids, polysaccharides, in particular starch and/or thermoplastic starch, polylactic acid (PLA), humic acids, lignin, maleic acid, erucic acid, oleic acid, stearates, silicagel, in particular fumed silica and/or zeolites, molasses, polydextrose, metal hydroxides, in particular AL(OH)₃ and/or Mg(OH)₂, aluminum oxide, in particular fused alumina, copolymers with acrylic acid, in particular copolymerisates from polystyrene and acrylic acid, acid anhydrides, in particular P₄O₁₀, glycosaminoglycans, in particular heparin, alkylamine alkoxides, methylene blue and/or methylene blue derivatives.

9. The composite material of claim 1, wherein the antimicrobial agent and/or the hydrophilizing agent are present as particles with an average diameter between 0.1 μm and 200 μm, in particular between 1 μm and 10 μm.

10. The composite material of claim 1, wherein the hydrophilizing agent has a water solubility of at most 10 g/l under SATP conditions and at a pH value of 7.

11. The composite material of claim 1, wherein the antimicrobial agent and/or the hydrophilizing agent are distributed in the supporting material and/or are applied to the supporting material as a coating and/or have at least partially a porous structure with an average pore size between 50 μm and 900 μm.

12. The composite material of claim 1, further comprising at least one sulfur scavenger, in particular a calcium, zinc, manganese, lead and/or iron compound, wherein the mass ratio of the sulfur scavenger related to the overall mass of the composite material is preferably between 0.01% and 0.5%.

13. The composite material of claim 1, wherein, the material is formed as a coating agent, in particular as a painting agent, varnish and/or anti-fouling paint.

14. The composite material of claim 1, wherein the mass portion of the antimicrobial agent related to the overall mass of the composite material is at least 0.1%, preferably at least 1.0%.

15. A method for producing a composite material, the method comprising:
providing a supporting material having at least one antimicrobial agent from the group of the metals and metal compounds as well as having at least one hydrophilizing agent, which increases the wettability of the surface of the composite material with water compared to the wettability of the surface of the composite material without addition of the hydrophilizing agent.

16. The method of claim 15, wherein the supporting material is coated with the antimicrobial agent and/or with the hydrophilizing agent and/or that the antimicrobial agent and/or the hydrophilizing agent are preferably uniformly distributed in the supporting material.

17. The method of claim 15, wherein, the antimicrobial agent and/or the hydrophilizing agent are ground to a grain size between 0.1 μm and 200 μm, in particular between 1 μm and 10 μm, before coating and/or distributing.

18. A method of using the composite material according to claim 1 for producing a cladding for a conduit, in particular for a pipeline for liquids, gases and/or sludges.
